(19) United States
(12) Patent Application Publication
(10) Pub. No.: US 2023/0262164 A1
(43) Pub. Date: Aug. 17, 2023

(54) EMERGENCY CALL SYSTEM, EMERGENCY CALL METHOD, AND PROGRAM

(71) Applicant: Nippon Telegraph and Telephone Corporation, Tokyo (JP)

(72) Inventor: Satoshi NEGISHI, Musashino-shi, Tokyo (JP)

(21) Appl. No.: 18/014,525

(22) PCT Filed: Jul. 6, 2020
(86) PCT No.: PCT/JP2020/026338

§ 371 Date: Jan. 5, 2023

(51) Int. Cl. H04M 3/51

(52) U.S. Cl. CPC H04M 3/5116; H04L 65/1104

(57) ABSTRACT

An emergency notification system includes: an emergency notification control device 10 that notifies an emergency institution of an emergency notification from an emergency notification agency; and a reception base that receives the emergency notification. The emergency notification control device includes a registration list in which the emergency notification agency is registered and a filtering unit that transmits only the emergency notification from the emergency notification agency registered in the registration list to the emergency institution, and the reception base receives the emergency notification transmitted by the filtering unit.

### TECHNICAL FIELD

The present invention relates to an emergency notification system, an emergency notification method, and a program.

### BACKGROUND ART

An emergency notification from a user using a network is transmitted as an emergency call to an emergency call reception base (emergency institution) corresponding to an area where the emergency notification is made. This system will be described in a little more detail. An emergency notification from a user is made with a telephone number of an emergency special number such as 110 or 119, and an emergency call reception base (hereinafter, a reception base) corresponding to an area where the emergency notification is made receives the emergency notification by a function on the network side. A unique telephone number is allocated to a reception base in each area, and the network side identifies the reception base with the unique telephone number and controls the connection route. Note that even when a user calls (makes a call to) a unique telephone number of a reception base on the network side, the network side performs control such that the call cannot arrive at the reception base. An emergency special number (emergency call) is given an emergency notification priority flag and treated specially in the network (Non Patent Literature 1).

Meanwhile, there is a service that temporarily makes a proxy response to an emergency notification from a user, collects information of the user, and transmits the emergency notification to an appropriate emergency notification reception institution by proxy. An emergency notification agency has a regional base somewhere, and when the emergency notification agency makes an emergency notification with an emergency special number (calls 110 or 119) from the regional base, similarly to a normal user, the emergency notification will arrive at a reception base corresponding to the regional base of the emergency notification agency, and will not arrive at a reception base in an area where the user using the emergency notification agency is located. Therefore, the emergency notification agency needs to make a call to the reception base in the area where the user using the emergency notification agency is located. However, even if a call is made to a telephone number allocated to the reception base, the call cannot arrive at the reception base because the network side handles the call similarly to a call from a normal user. Therefore, the emergency notification agency copes with this problem by setting an emergency call flag.

### CITATION LIST

### Non Patent Literature

Non Patent Literature 1: Muneaki Ogawa, et al., “Standardization trend of emergency notification and standardization of IP network interface specification”, NTT Technical Journal, February 2018

### SUMMARY OF INVENTION

### Technical Problem

However, on a SIP signal, the emergency call flag and the emergency notification priority flag, which indicates that the notification is preferentially connected over a call by a normal user and that a band for an emergency notification can be used, are not distinguished from each other, and thus, the reception base cannot distinguish an emergency notification from a general user and an emergency notification from an emergency notification agency. Therefore, an emergency notification from an emergency notification agency is not connected to the emergency institution in the network. That is, there is a problem that an emergency notification from an emergency notification agency is not connected to the emergency institution.

The present invention has been made in view of this problem, and an object thereof is to provide an emergency notification system, an emergency notification method, and a program capable of connecting an emergency notification from an emergency notification agency to an emergency institution.

### Solution to Problem

The gist of an emergency notification system according to an aspect of the present invention is an emergency notification system including: an emergency notification control device that notifies an emergency institution of an emergency notification from an emergency notification agency; and a reception base that receives the emergency notification, wherein the emergency notification control device includes a registration list in which the emergency notification agency is registered and a filtering unit that transmits only the emergency notification from the emergency notification agency registered in the registration list to the emergency institution, and the reception base receives the emergency notification transmitted by the filtering unit.

Furthermore, the gist of an emergency notification system according to another aspect of the present invention is an emergency notification system including: an emergency notification control device that notifies an emergency institution of an emergency notification from an emergency notification agency; and a reception base that receives the emergency notification, wherein the emergency notification control device includes an authentication control unit that generates a hash character string from a user name and a password included in the emergency notification, transmits the hash character string to the emergency institution, and transmits a control signal to the emergency notification agency based on an authentication result received from the emergency institution, and the reception base includes an authentication unit that receives the hash character string and performs digest authentication on the hash character string.

Furthermore, the gist of an emergency notification method according to an aspect of the present invention is an emergency notification method performed by the emergency notification system, the emergency notification method including: generating, by the emergency notification control device, a hash character string from a user name and a password included in the emergency notification, transmitting the hash character string to the emergency institution, and transmitting a control signal to the emergency notification agency based on an authentication result received from the emergency institution; and receiving, by the reception base, the hash character string and performing digest authentication on the hash character string.

Furthermore, the gist of a program according to an aspect of the present invention is a program for causing a computer to function as the emergency notification system.

### Advantageous Effects of Invention

According to the present invention, it is possible to connect an emergency notification from an emergency notification agency to an emergency institution.

### BRIEF DESCRIPTION OF DRAWINGS

FIG. 1 is a block diagram illustrating a functional configuration example of an emergency notification system according to a first embodiment of the present invention.

FIG. 2 is a diagram illustrating an operation sequence of an emergency notification control device and a reception base illustrated in FIG. 1.

FIG. 3 is a block diagram illustrating a functional configuration example of an emergency notification system according to a second embodiment of the present invention.

FIG. 4 is a diagram illustrating an operation sequence of an emergency notification control device and a reception base illustrated in FIG. 3.

FIG. 5 is a block diagram illustrating a configuration example of a general-purpose computer system.

### DESCRIPTION OF EMBODIMENTS

Hereinafter, embodiments of the present invention will be described with reference to the drawings. The same reference signs are given to the same components in a plurality of drawings, and the description thereof will not be repeated.

### First Embodiment

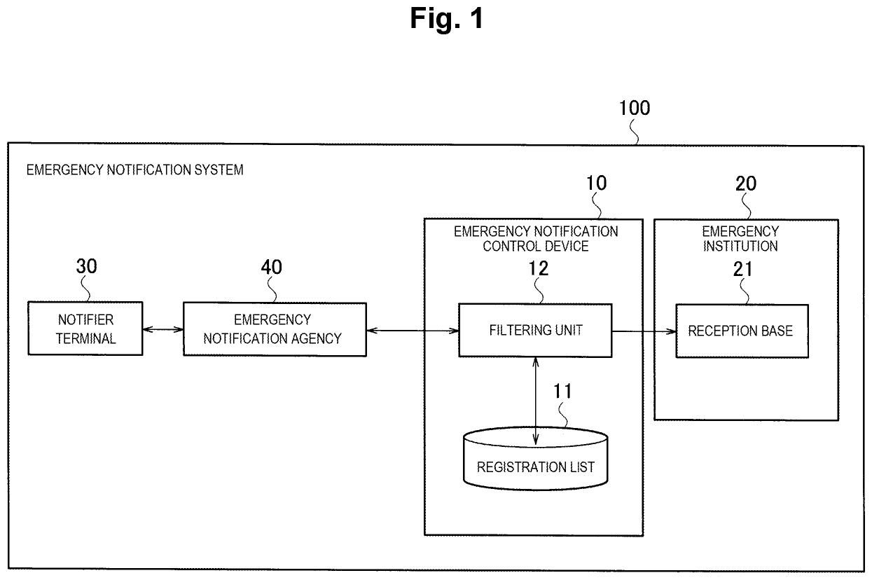

FIG. 1 is a block diagram illustrating a functional configuration example of an emergency notification system according to a first embodiment of the present invention. An emergency notification system 100 illustrated in FIG. 1 is a system that connects an emergency notification to an emergency institution such as a police department or a fire department.

The emergency notification system 100 includes a notifier terminal 30, an emergency notification agency 40, an emergency notification control device 10, and an emergency institution 20. These functional components operate on an IP network. The IP network (not illustrated) is interposed between the functional components, and the session initiation protocol (SIP) is adopted as a protocol of communication control.

FIG. 1 illustrates only a relationship between the emergency institution 20 and the notifier terminal 30 possessed by a user having a contract with the emergency notification agency 40 that provides an emergency notification service. An emergency notification from a notifier terminal (not illustrated) having no contract with the emergency notification agency 40 is given an emergency notification priority flag by a terminal accommodation device (not illustrated) on the transmission network side, and is connected to, for example, the emergency institution 20 corresponding to an area where the notifier makes the emergency notification. In FIG. 1, the description of the route is omitted.

The notifier terminal 30 is any one of a fixed-line phone, an information processing device, and a mobile terminal.

The emergency notification agency 40 receives an emergency notification made from the notifier terminal 30 possessed by a subscriber, adds information regarding whereabouts of the notifier, and transmits the emergency notification to the emergency institution 20. The emergency notification agency 40 is, for example, an operator. Alternatively, the emergency notification agency 40 may be a server managed by the emergency notification agency 40.

The emergency notification control device 10 includes a registration list 11 and a filtering unit 12. The registration list 11 is a list in which the emergency notification agency 40 is registered. The registration list 11 is, for example, a list of telephone numbers of the emergency notification agency 40.

The filtering unit 12 transmits only an emergency notification from the emergency notification agency 40 registered in the registration list 11 to the emergency institution 20. In this case, an emergency call flag indicating an emergency call may be given to the name and whereabouts of the notifier and transmitted.

The emergency institution 20 includes a reception base 21. The reception base 21 receives both an emergency notification from the emergency notification agency 40 and an emergency notification from a notifier terminal (not illustrated) having no contract with the emergency notification agency 40. The reception base 21 is an input/output device (console) that outputs information to an operator engaged in the emergency institution 20 and to which the operator inputs information.

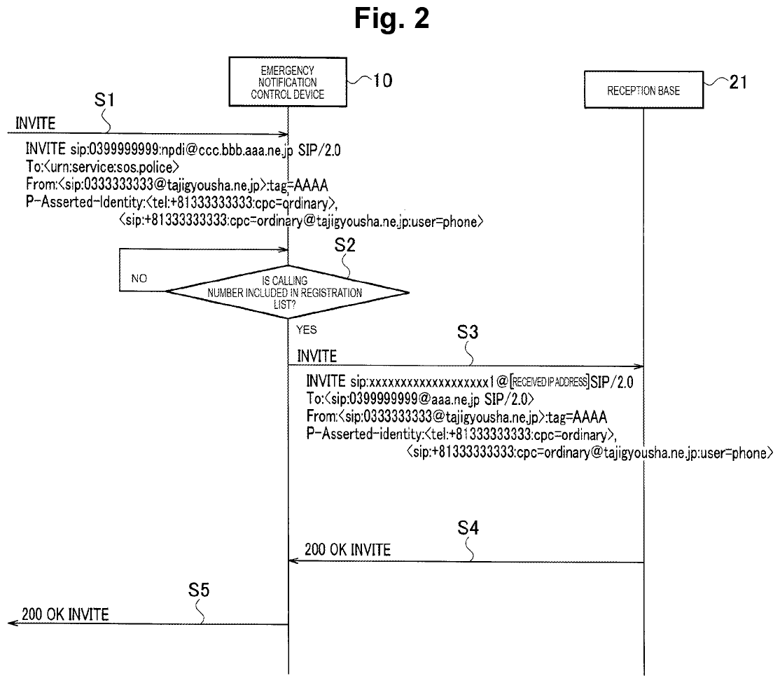

FIG. 2 is a diagram illustrating an operation sequence of the emergency notification control device 10 and the emergency institution 20 included in the emergency notification system 100. The operation will be described with reference to FIG. 2.

The emergency notification control device 10 receives an emergency notification from the emergency notification agency 40 (step S1). The emergency notification starts with an INVITE message. A header “To” indicates a destination of the emergency notification. A header “From” indicates a calling number of the emergency notification agency 40.

The filtering unit 12 determines whether the calling number is included in the registration list 11 (step S2). In a case where the calling number is included in the registration list 11, the emergency notification starting with the INVITE message is transmitted as it is to the reception base 21 of the emergency institution 20 (step S3).

In a case where the calling number is not included in the registration list 11, the emergency notification control device 10 does not transmit the emergency notification to the reception base 21. In this case, an error response indicating that the emergency notification cannot be transmitted may be transmitted to the emergency notification agency 40.

Upon receiving the emergency notification, the reception base 21 of the emergency institution 20 returns a response of 200 OK (step S4). The emergency notification is then dealt with in a predetermined procedure. The emergency notification control device 10 transfers the received response of 200 OK to the emergency notification agency 40 (step S5).

As described above, an emergency notification system 100 according to the present embodiment is an emergency notification system including: an emergency notification control device 10 that notifies an emergency institution 20 of an emergency notification from an emergency notification agency 40; and a reception base 21 that receives the emergency notification, wherein the emergency notification control device 10 includes a registration list 11 in which the emergency notification agency 40 is registered and a filtering unit 12 that transmits only the emergency notification from the emergency notification agency 40 registered in the registration list 11 to the emergency institution, and the reception base 21 receives the emergency notification transmitted by the filtering unit 12. With this configuration, the emergency notification from the emergency notification agency 40 can be connected to the emergency institution 20.

### Second Embodiment

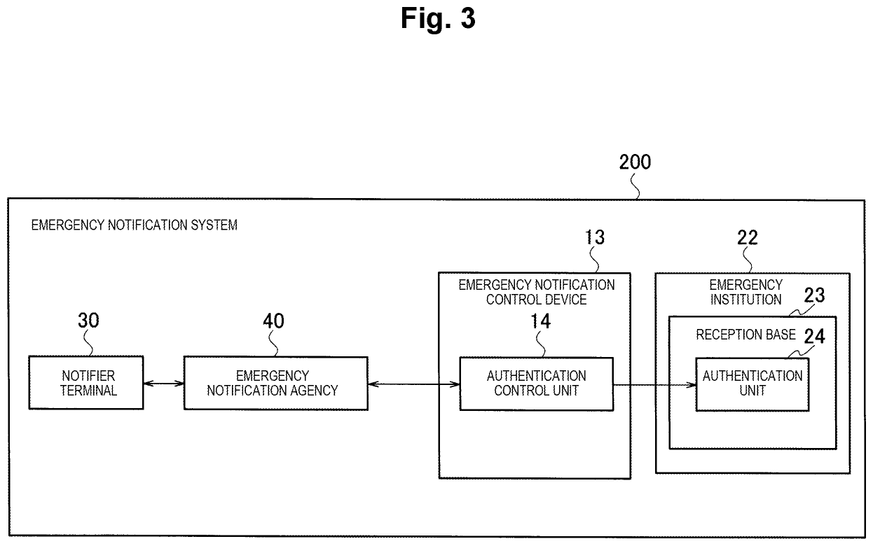

FIG. 3 is a block diagram illustrating a functional configuration example of an emergency notification system according to a second embodiment of the present invention. An emergency notification system 200 illustrated in FIG. 3 is different in that an emergency notification control device 13 includes an authentication control unit 14 and a reception base 23 includes an authentication unit 24.

The authentication control unit 14 generates a hash character string from a user name and a password included in an emergency notification, transmits the hash character string to the reception base 23, and transmits a control signal to an emergency notification agency 40 based on an authentication result received from the reception base 23.

The authentication unit 24 included in the reception base 23 receives the hash character string generated by the authentication control unit 14 of the emergency notification control device 13 and performs digest authentication on the hash character string.

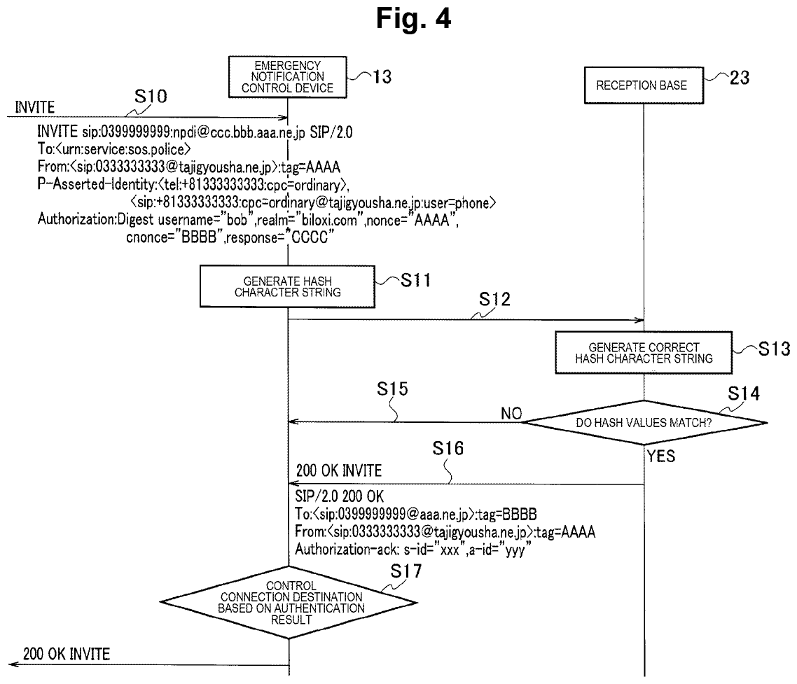

FIG. 4 is a diagram illustrating an operation sequence of the emergency notification control device 10 and an emergency institution 22 included in the emergency notification system 200. The operation will be described with reference to FIG. 2.

The emergency notification control device 10 receives an emergency notification from the emergency notification agency 40 (step S10). The emergency notification received here is different from the above emergency notification in that the emergency notification received here includes authentication information for digest authentication. The authentication information is information indicated in two lines starting with “Authorization:”.

The authentication control unit 14 generates a hash character string by using a user name (bob), a password, a nonce character string (AAAA), a cnonce character string (BBBB), and the like (step S11). The hash character string is transmitted to the emergency institution 22 (step S12).

The authentication unit 24 included in the emergency institution 22 performs digest authentication on the received hash character string. In the digest authentication, a correct hash value is calculated from the random character string (nonce/cnonce) or the like transmitted from the authentication control unit 14 and the previously recorded hashed password (step S13), and it is determined whether hash values match (step S14).

In a case where the hash values match, the authentication unit 24 transmits an s-id as a service ID and an a-id as an auxiliary information ID to the authentication control unit 14 together with a response of 200 OK indicating the authentication success (step S16). In a case where the hash values do not match, an error response is transmitted to the authentication control unit 14 (step S15).

The authentication control unit 14 controls the emergency notification agency 40 based on the received SIP response (200 OK or the like), service ID (s-id), and auxiliary information ID (a-id) (step S17).

The service ID and the auxiliary ID are IDs for controlling a network on the transmission side of the emergency notification. The service ID is an ID for a network function. The auxiliary ID is an ID for controlling whether the network function is enabled or disabled and for performing guidance connection.

As described above, an emergency notification system 200 according to the present embodiment is an emergency notification system including: an emergency notification control device 13 that notifies an emergency institution 20 of an emergency notification from an emergency notification agency 40; and a reception base 23 that receives the emergency notification, wherein the emergency notification control device 13 includes an authentication control unit 14 that generates a hash character string from a user name and a password included in the emergency notification, transmits the hash character string to the emergency institution 22, and transmits a control signal to the emergency notification agency 40 based on an authentication result received from the emergency institution 22, and the reception base 23 includes an authentication unit 24 that receives the hash character string and performs digest authentication on the hash character string. With this configuration, the emergency notification from the emergency notification agency 40 can be connected to the emergency institution 20. Furthermore, controlling the network on the transmission side on the basis of the control signals (the service ID and the auxiliary ID) enables finer control.

(Emergency Notification Method)

An emergency notification method performed by an emergency notification system 200 according to the present embodiment is an emergency notification method performed by an emergency notification system including an emergency notification control device 13 that notifies an emergency institution 22 of an emergency notification from an emergency notification agency 40 and a reception base 23 that receives the emergency notification, the emergency notification method including: generating, by the emergency notification control device 13, a hash character string from a user name and a password included in the emergency notification, transmitting the hash character string to the emergency institution 22 (step S12 in FIG. 4), and transmitting a control signal to the emergency notification agency 40 based on an authentication result received from the emergency institution 22; and receiving, by the reception base 23, the hash character string and performing digest authentication on the hash character string (step S14 in FIG. 4).

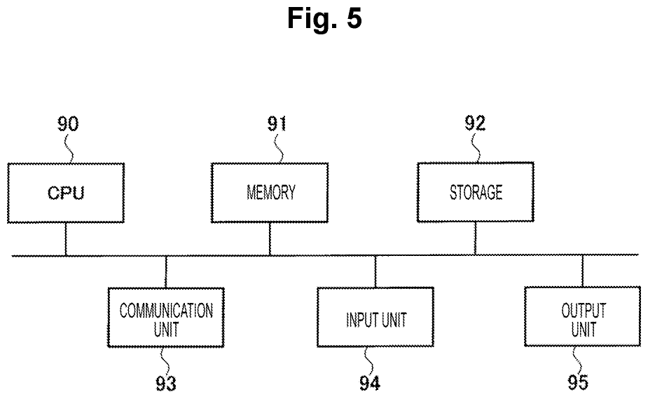

Each of the emergency notification systems 100 and 200 can be implemented by a general-purpose computer system illustrated in FIG. 5. For example, in a general-purpose computer system including a CPU 90, a memory 91, a storage 92, a communication unit 93, an input unit 94, and an output unit 95, each function of the prediction device 100 is implemented by the CPU 90 executing a predetermined program loaded on the memory 91. The predetermined program can be recorded in a computer-readable recording medium such as an HDD, an SSD, a USB memory, a CD-ROM, a DVD-ROM, or an MO, or can be distributed via a network.

The present invention is not limited to the above embodiments, and modifications can be made within the scope of the gist of the present invention. For example, the description has been given assuming that the registration list 11 records the telephone numbers of the emergency notification agency 40, but the present invention is not limited to this example. Any information may be recorded as long as the emergency notification agency 40 can be identified.

As described above, it is a matter of course that the present invention includes various embodiments and the like not described herein. Therefore, the technical scope of the present invention is defined only by the matters specifying the invention according to the claims appropriate from the above description.

### REFERENCE SIGNS LIST

10, 13 Emergency notification control device
11 Registration list
12 Filtering unit
14 Authentication control unit
20, 22 Emergency institution
21, 23 Reception base
24 Authentication unit
30 Notifier terminal
40 Emergency notification agency
100, 200 Emergency notification system

1. An emergency notification system comprising: an emergency notification control device for notifying an emergency institution of an emergency notification from an emergency notification agency; and a reception base for receiving the emergency notification, wherein
the emergency notification control device includes a registration list in which the emergency notification agency is registered and
a filtering unit, including one or more processors, configured to transmit only the emergency notification from the emergency notification agency registered in the registration list to the emergency institution, and
the reception base is configured to receive the emergency notification transmitted by the filtering unit.

2. The emergency notification system of claim 1, wherein
the emergency notification control device includes an authentication control unit including one or more processors, configured to generate a hash character string from a user name and a password included in the emergency notification, transmit the hash character string to the emergency institution, and transmit a control signal to the emergency notification agency based on an authentication result received from the emergency institution, and
the reception base includes an authentication unit, including one or more processors, configured to receive the hash character string and perform digest authentication on the hash character string.

3. The emergency notification system according to claim 2, wherein
the control signal includes
a service ID for controlling an operation of a network on a side of the emergency notification control device and an auxiliary information ID indicating a type of auxiliary information for assisting the service ID.

4. An emergency notification method performed by an emergency notification system including an emergency notification control device for notifying an emergency institution of an emergency notification from an emergency notification agency and a reception base for receiving the emergency notification, the emergency notification method comprising:
generating, by the emergency notification control device, a hash character string from a user name and a password included in the emergency notification, transmitting the hash character string to the emergency institution, and transmitting a control signal to the emergency notification agency based on an authentication result received from the emergency institution; and
receiving, by the reception base, the hash character string and performing digest authentication on the hash character string.

5. A non-transitory computer-readable storage medium storing a program for causing a computer to function as an emergency notification system an emergency notification control device and reception base to perform operations comprising:
generating, by the emergency notification control device of the emergency notification system, a hash character string from a user name and a password included in the emergency notification, transmitting the hash character string to the emergency institution, and transmitting a control signal to the emergency notification agency based on an authentication result received from the emergency institution; and
receiving, by the reception base of the emergency notification system, the hash character string and performing digest authentication on the hash character string.

6. The non-transitory computer-readable storage medium according to claim 5, wherein
the control signal includes a service ID for controlling an operation of a network on a side of the emergency notification control device and an auxiliary information ID indicating a type of auxiliary information for assisting the service ID.

7. The emergency notification method according to claim 4, wherein
the control signal includes a service ID for controlling an operation of a network on a side of the emergency notification control device and an auxiliary information ID indicating a type of auxiliary information for assisting the service ID.
